(19) United States
(12) Patent Application Publication
(10) Pub. No.: US 2025/0083159 A1
(43) Pub. Date: Mar. 13, 2025

(54) Sequential transitory spraying from a pipeline

(71) Applicant: Elad Movshoviz, Sussya (IL)

(72) Inventor: Elad Movshoviz, Sussya (IL)

(21) Appl. No.: 18/928,041

(22) Filed: Oct. 27, 2024

Related U.S. Application Data
(63) Continuation-in-part of application No. PCT/IL2023/050431, filed on Apr. 27, 2023.
(60) Provisional application No. 63/363,758, filed on Apr. 28, 2022.

(51) Int. Cl. B05B 1/32; A01M 7/00; B05B 1/20; B05B 12/04

(52) U.S. Cl. CPC B05B 1/323; B05B 1/202; B05B 12/04; A01M 7/0089

(57) ABSTRACT

A valve assembly for sequential, transitory high-pressure spraying in a pipeline conveying pressurized liquid in which the pressurized liquid drives a spray valve into a momentary open position to enable a transitory spray of pressurized liquid and then open an outlet valve to enable throughput of the pressurized liquid to the next valve assembly deployed in the pressurized pipeline.

### CROSS REFERENCES TO RELATED APPLICATIONS

This application is a Continuation-in-Part of PCT International Application No. PCT/IL2023/050431, filed on 27 Apr. 2023, which claims priority to U.S. Provisional Application No. 63/363,758, filed on 28 Apr. 2022, each of which is incorporated herein by reference in its entirety.

### TECHNICAL FIELD

The present invention relates generally to agriculture and in particular to sequential, transitory high-pressure spraying from a pipeline.

### BACKGROUND

Pesticides are often used in agriculture to improve the outcome of plant production. The term pesticide includes all of the following, as sub-categories thereof: herbicide; insecticide; nematicide, molluscicide, piscicide, avicide, rodenticide, bactericide, insect repellent, animal repellent, antimicrobial, fungicide, and lampricide, without limitation. Most pesticides are intended to serve as plant protection products (also known as crop protection products), which in general, protect plants from weeds, fungi, or insects.

Pesticides may be applied from the air, e.g. by a crop-duster, or by spraying. Spraying is preferably done without a human presence on site, due to issues of potential toxicity.

High pressure spraying, involves the use of pressures of around 15-30 Bar (i.e. about 15-30 atmospheres, or 1,500,000-3,000,000 Pascals). In a typical installation, a pesticide is mixed with a carrying liquid, such as water, to a pre-determined dilution, and then sprayed on a target foliage.

### SUMMARY

Certain examples enable a valve assembly for spraying comprising: an input port; a spray port; a spray valve between said input port and said spray port; an exit port; and an outlet valve between said input port and said exit port, wherein in response to a flow of a liquid received at said input port, allow exit of said flow of said liquid from said spray port through said spray valve, and subsequently automatically close said spray valve and said automatically open said outlet valve so that said flow of said liquid is output from said exit port, where a duration at which said spray valve is opened is either predetermined or is responsive to an amount of liquid flowing through said spray valve.

Independently, certain examples enable a system for spraying comprising: a pump; and a plurality of valve assemblies connected in series by respective pipe sections, each of said valve assemblies comprising: an input port coupled to a first end of a preceding respective pipe section; a spray port; a spray valve between said input port and said spray port; an exit port coupled to a first end of a subsequent pipe section; and an outlet valve between said input port and said exit port, wherein in response to a flow of a liquid received at said input port from said preceding respective pipe section of at least a predetermined first pressure, allow exit of said flow of said liquid from said spray port through said spray valve for a predetermined duration, or until a predetermined amount of liquid has flown through said spray valve, and subsequently automatically close said spray valve and automatically open said outlet valve so that said flow of said liquid is output from said exit port to said subsequent pipe section, a first of said plurality of valve assemblies coupled to said pump by a preceding respective pipe section. The predetermined amount can be a predetermined volume or a predetermined mass of the liquid.

Independently, certain examples enable a method of spraying of foliage, the method comprising: providing a plurality of valve assemblies connected in series by respective pipe sections, each of said plurality of valve assemblies exhibiting a spray port; providing a flow of liquid at a predetermined first pressure, or above, to a first of the plurality of valve assemblies connected in series; each of said plurality of valve assemblies: outputting a pre-determined amount of said liquid, or said liquid for a predetermined duration, from said spray port; blocking the flow of said liquid from a subsequent one of the plurality of valve assemblies until the pre-determined amount of said liquid has output from said spray port, or said liquid has been output for the predetermined duration from said spray port; and passing the flow of said liquid to the subsequent one of the plurality of valve assemblies once the pre-determined amount of said liquid has output from said spray port, or said liquid has been output for the predetermined duration from said spray port.

According to the teachings of the present invention there is provided a system for sequential spraying along at least one pipeline, the system including: a series of valve assemblies deployed along the pipeline, wherein each of the valve assemblies includes: a spray valve configured to release a transitory spray through a spray port when the spray valve is subjected to a pressurized liquid in the pipeline, and-an outlet valve configured to open after the release of the transitory spray so as to enable passage of the pressurized liquid through an outlet port to a subsequent valve assembly.

According to a further feature of the present invention, the spray valve is configured to release the transitory spray responsively to a threshold pressure of the pressurized liquid.

According to a further feature of the present invention, the spray valve is implemented as a biased, plunger having a flow passageway aligning with the spray port when driven by the threshold pressure.

According to a further feature of the present invention, the plunger is biased to recoil responsively to a pressure less than the threshold pressure applied by the pressurized liquid.

According to a further feature of the present invention, there is also provided, a plunger lock configured to releasably lock the plunger into place after the recoil.

According to a further feature of the present invention, the outlet valve is configured to open responsively to the recoil of the plunger.

According to a further feature of the present invention, the spray valve is implemented as a biased, flow restrictor operative to open a flow path to the spray port responsively to a threshold pressure applied by the pressurized liquid in the pipeline.

According to a further feature of the present invention, the outlet valve is operative to open responsively to an outlet threshold pressure applied by the pressurized liquid, the outlet threshold pressure exceeding the threshold pressure, the outlet valve disposed at junction between an assembly flow path and a spray valve bypass loop.

According to a further feature of the present invention, the spray valve is implemented as a biased, axial plunger having a flow passageway aligning with the spray port when driven axially by the threshold pressure.

According to a further feature of the present invention, the outlet valve is implemented as the biased, axial plunger having a discharge port operative to align with the outlet port when further driven by the pressure pressurized liquid.

There is also provided according to the teachings of the present invention, a method of sequential spraying pressurized liquid from a series of spray assemblies serially deployed in at least one pipeline, the method including: transitorily releasing a spray of the pressurized liquid in the pipeline through a spray valve of a spray assembly of the series of spray assemblies when the spray valve is subjected to the pressurized liquid; and opening an outlet valve of the spray assembly after the transitorily releasing the spray so as to apply the pressurized liquid to a subsequent spray assembly of the series of spray assembles deployed downstream in the pipeline.

According to a further feature of the present invention, the releasing a spray of the pressurized liquid in the pipeline is implemented by transitorily aligning a flow passageway of the spray valve in liquid communication with the pressurized liquid with the spray port.

According to a further feature of the present invention, the opening of an outlet valve of the spray assembly is implemented by removing a flow inhibitor shielding an outlet port.

According to a further feature of the present invention, the pressurized liquid in the pipeline through a spray valve is implemented by transitorily removing a flow restrictor impeding flow to a spray port.

According to a further feature of the present invention, the opening of an outlet valve of the spray assembly is implemented by applying a heighten pressure of the pressurized liquid to the outlet valve.

According to a further feature of the present invention, there is also provided, depressurizing the pressurized liquid so as to close the outlet valve.

According to a further feature of the present invention, the releasing a spray of the pressurized liquid in the pipeline is implemented by axially driving an axial plunger having a flow passageway in communication with the pressurized liquid, the axially driving causing alignment of the flow passageway with a spray port.

According to a further feature of the present invention, the opening an outlet valve of the spray assembly is implemented by further axially driving the axial plunger having a discharge port in communication with the pressurized liquid, the further axially driving causing alignment of the discharge port with the outlet port.

According to a further feature of the present invention, there is also provided, depressurizing the pressurized liquid so as to close the outlet valves.

There is also provided according to the teachings of the present invention, a valve assembly for sequential spraying along at least one pipeline, including: a spray valve configured to release a transitory spray through a spray valve when a pressurized liquid is applied to the spray valve deployed in the pipeline, and an outlet valve configured to open after the release of the transitory spray so as to enable passage of the pressurized liquid through an outlet port.

Additional features and advantages of the invention will become apparent from the following drawings and description.

### BRIEF DESCRIPTION OF THE DRAWINGS

For a better understanding of certain embodiments and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments only and are presented in the cause of providing what is believed to be the most useful and readily understood description of the principles and conceptual aspects. In this regard, no attempt is made to show structural details in more detail than is necessary for a fundamental understanding, the description taken with the drawings making apparent to those skilled in the art how the several forms may be embodied in practice. In the accompanying drawings:

FIGS. 1A-1B illustrate high level block diagrams of a first example of a valve assembly for pressure spraying;

FIGS. 2A-2B illustrate a cross-sectional side view of an example valve assembly for sequential, transitory spraying utilizing a spring mechanism for control of an outlet valve of the valve assembly;

FIG. 3A illustrates a cross-sectional cut away view of another example valve assembly employing compression springs for both spray and outlet valve biasing;

FIG. 3B is a cross-sectional view of a valve assembly for sequential, transitory spraying depicting a flow linkage between spray and outlet valves, according to an example

FIG. 4 illustrates an example system for sequential, transitory spraying employing processor control;

FIG. 5 illustrates a high-level flow chart of an example method of sequential, transitory spraying, according to an example;

FIGS. 6A-6B are schematic, cross-sectional side views depicting stages of operation of a first embodiment of a sequential, transitory valve assembly;

FIGS. 7A-7B are schematic, cross-sectional side views depicting two stages of operation of a second embodiment of a sequential, transitory valve assembly;

FIG. 8A is a schematic perspective view of a third embodiment of a transitory valve assembly employing an axial plunger; and

FIGS. 8B-8E are schematic, cross-sectional side views depicting four stages of operation of the valve assembly of FIG. 8A.

### DETAILED DESCRIPTION

The present examples provide for a valve assembly for pressure spraying, and a system utilizing such a valve assembly. The valve assembly optionally and preferably comprises: an input port to receive a liquid under pressure, that is preferably at, or above a predetermined pressure, for example at around 15 Bar; a normally open spray valve in communication with a spray port, to release a predetermined amount of liquid from the spray port, or to release liquid for a predetermined duration, from the spray port after arrival of a liquid at the input port. Preferably, the spray valve is automatically closed after the release of the predetermined amount of liquid or after the predetermined period. The valve assembly optionally and preferably also comprises an outlet valve that is automatically opened simultaneously with the closing of the spray valve or after the spray valve has closed. In one example, when the spray valve is open, the pressure applied by the liquid to the outlet valve is less than a predetermined first pressure, and as a result the outlet valve remains in a closed state. When the spray valve is closed, the pressure applied by the liquid to the outlet valve is at least the predetermined first pressure, and as a result the outlet valve opens allowing the liquid to proceed through the outlet port.

In accordance with an aspect of the invention there is provided a system for sequential transitory spraying along at least one pipeline when subjected to a pressurized liquid. The system comprises a series of valve assemblies deployed along the pipeline, wherein each of the valve assemblies comprises: (A) a spray valve configured to release a transitory spray through a spray port when the spray valve is subjected to a change in pressure of the pressurized liquid in the pipeline, wherein the port: (1) responsively opens when the pressure increases at or above a threshold pressure; (2) automatically closes thereafter; and (3) reopens to release a further transitory spray, only (a) if the pressure of the pressurized liquid initially reduces below the threshold pressure; and (b) when the pressure of the pressurized liquid subsequently increases above the threshold pressure. Each of the valve assemblies further comprises (B) an outlet valve configured to: (i) open after the release of the transitory spray when the pressurized liquid increases at or above an outlet-threshold pressure; (ii) to remain open, so as to enable passage of the pressurized liquid downstream through an outlet port to a subsequent valve assembly; and (iii) to close when the pressurized liquid reduces below the outlet-threshold pressure.

In some embodiments, the outlet-threshold pressure exceeds the threshold pressure. The spray valve may be implemented as a biased plunger having a flow passageway aligning with the spray port when driven by the threshold pressure. The plunger may be biased to recoil responsively to a pressure which is less than the threshold-pressure applied by the pressurized liquid. The system may further comprise a plunger lock configured to releasably lock the plunger into place after the recoil. The outlet valve may be configured to open responsively to the recoil of the plunger.

In some embodiments, the spray valve is implemented as a biased, flow restrictor operative to open a flow path to the spray port responsively to a threshold pressure applied by the pressurized liquid in the pipeline.

In some embodiments, the outlet valve is operative to open responsively to an outlet-threshold pressure applied by the pressurized liquid, the outlet-threshold pressure exceeding the threshold pressure, the outlet valve disposed at junction between an assembly flow path and a spray valve bypass loop.

In some embodiments, the spray valve is implemented as a biased, axial plunger having a flow passageway aligning with the spray port when driven axially by the threshold pressure. The outlet valve may be implemented as the biased, axial plunger having a discharge port operative to align with the outlet port when further driven by the pressure pressurized liquid.

In accordance with another aspect of the invention there is provided a method of sequential transitory spraying of pressurized liquid from a series of spray assemblies serially deployed in at least one pipeline. The method comprises: (A) transitorily releasing a transitory spray of the pressurized liquid in the pipeline through a spray valve of a spray assembly of the series of spray assemblies when the spray valve is subjected to a change in pressure of the pressurized liquid, by: (1) opening a spray port of the spray valve in response to an increase of pressure at or above a threshold pressure; (2) automatically closing the spray port after the release of the transitory spray; and (3) reopening the spray port to release a further transitory spray only (a) if the pressure of the pressurized liquid initially reduces below the threshold pressure; and (b) when the pressure of the pressurized liquid subsequently increases above the threshold pressure. The method further comprises: (B) opening and closing an outlet valve of the spray assembly, by (i) opening the outlet valve after the release of the transitory spray when the pressurized liquid increases at or above an outlet-threshold pressure; (ii) maintaining the outlet valve open so as to apply the pressurized liquid downstream through an outlet port to a subsequent spray assembly of the series of spray assembles deployed downstream in the pipeline; and (iii) closing the outlet valve when the pressurized liquid reduces below the outlet-threshold pressure.

In some embodiments, the releasing a spray of the pressurized liquid in the pipeline is implemented by transitorily aligning a flow passageway of the spray valve in liquid communication with the pressurized liquid with the spray port.

In some embodiments, the opening of an outlet valve of the spray assembly is implemented by removing a flow inhibitor shielding an outlet port.

In some embodiments, the transitorily releasing a spray of the pressurized liquid in the pipeline through a spray valve is implemented by transitorily removing a flow restrictor impeding flow to a spray port.

In some embodiments, the opening of an outlet valve of the spray assembly is implemented by applying a heightened pressure of the pressurized liquid to the outlet valve. The method may further comprise depressurizing the pressurized liquid so as to close the outlet valve.

In some embodiments, the releasing of a spray of the pressurized liquid in the pipeline is implemented by axially driving an axial plunger having a flow passageway in communication with the pressurized liquid, the axially driving causing alignment of the flow passageway with a spray port.

In some embodiments, the opening an outlet valve of the spray assembly is implemented by further axially driving the axial plunger having a discharge port in communication with the pressurized liquid, the further axially driving causing alignment of the discharge port with the outlet port. The method may further comprise depressurizing the pressurized liquid so as to close the outlet valves.

In accordance with another aspect of the invention, there is provided a valve assembly deployed in a pipeline for sequential transitory spraying along the pipeline when subjected to a pressurized liquid. The valve assembly comprises: (A) a spray valve configured to release a transitory spray through a spray port when a pressurized liquid is applied to the spray valve deployed in the pipeline, wherein the port: (1) responsively opens when the pressure increases at or above a threshold pressure; (2) automatically closes thereafter; and (3) reopens to release a further transitory spray only (a) if the pressure of the pressurized liquid initially reduces below the threshold pressure; and (b) when the pressure of the pressurized liquid subsequently increases above the threshold pressure. The valve assembly further comprises: (B) an outlet valve configured to: (i) open after the release of the transitory spray when the pressurized liquid increases at or above an outlet-threshold pressure; (ii) to remain open, so as to enable passage of the pressurized liquid downstream through an outlet port to a subsequent valve assembly; and (iii) to close when the pressurized liquid reduces below the outlet-threshold pressure.

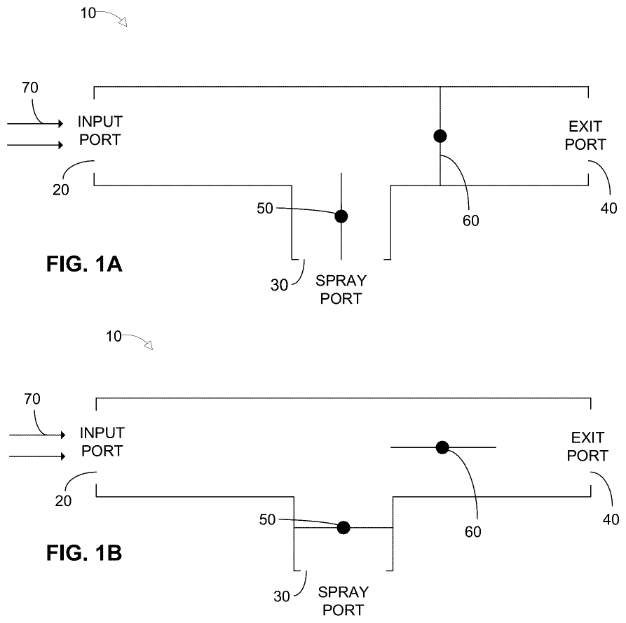

FIGS. 1A-1B illustrate high level block diagrams of a valve assembly 10 for pressure spraying. In the illustrated embodiments which are not to be considered as limiting, valve assembly 10 comprises an input port 20; a spray port 30; an exit port 40; a spray valve 50 and an outlet valve 60. Input port 20 receives a liquid under pressure and may exhibit a threaded section to receive a section of pipe, such as a hose. Exit port 40 may provide a liquid under pressure from input port 40, and may exhibit a threaded section to receive a section of pipe, such as a hose. Spray port 30 may exhibit a spray nozzle, or a spray head without limitation, or may be threaded to allow for connection of a spray nozzle or spray head. Spray valve 50 and outlet valve 60 are illustrated as butterfly valves, without limitation.

Spray valve 50 is in one example normally open, i.e. in the absence of liquid under pressure spray valve 50 is open. In particular, in one example, in the absence of liquid above a predetermined second pressure spray valve 50 is in an open state. In certain embodiments, the predetermined second pressure is less than a predetermined first pressure and in others can be the same. A suitable value for the predetermined first pressure is from about 15 bar. A suitable value for the predetermined second pressure is from about 2 bar to about 3 bar. Outlet valve 60 is preferably normally closed in a certain embodiment, so that in the absence of liquid applied to the outlet valve, or in the presence of liquid applied to the outlet valve with a pressure less than the predetermined first pressure, the outlet valve is in a closed state. Spray port 30 is in liquid communication with input port 20 when spray valve 50 is open (or in the open state), allowing liquid from input port 20 to flow through spray port 30. When spray valve 50 is closed (or in the closed state), liquid from input port 20 does not flow through spray port 30. Exit port 40 is in liquid communication with input port 20 when outlet valve 60 is open (or in the open state), allowing liquid from input port 20 to flow through exit port 40. When outlet valve 60 is closed (or in the closed state), liquid from input port 20 does not flow through exit port 40.

In operation, and as illustrated in the general embodiment of FIG. 1A, prior to receipt of a liquid 70 under pressure at input port 20, spray valve 50 is open, and outlet valve 60 is closed. When liquid 70, of at least the predetermined first pressure, arrives at input port 20, a portion of the liquid 70 exits spray port 30, preferably under pressure, responsive to the open state of spray valve 50. Such a liquid may be applied to foliage in accordance with pre-placement of spray port 30, or attachments to spray port 30, in a desired location and direction. In some examples, since liquid 70 finds an exit through spray port 30, the pressure applied by liquid 70 to outlet valve 60 is less than the predetermined first pressure, and outlet valve 60 remains closed.

After a predetermined amount of liquid 70 has flowed through spray valve 50, or after a predetermined duration during which liquid 70 has flowed through spray valve 50, as illustrated in FIG. 1B, spray valve 50 closes automatically, i.e. moves to the closed state. Liquid 70 thus applies its pressure against outlet valve 60. In some examples, responsive to the pressure applied by liquid 70 of at least the predetermined first pressure, outlet valve 60 opens responsive to the predetermined first pressure, and liquid 70 thus flows through valve assembly 10 from input port 20 and exits from exit port 40. In some embodiments at least one of, more preferably both, of valves 50 and 60 are autonomic and are configured to switch between their closed and opened states only in response to the pressure of the liquid contacting these valves, without any electrical control. Alternatively, one or both of spray valve 50 and outlet valve 60 are electronically controlled. A small amount of pressure may be lost in valve assembly 10. In the example in which a predetermined volume of liquid 70 is used to close spray valve 50, spray valve 50 may be implemented by a volumetric shut-off valve.

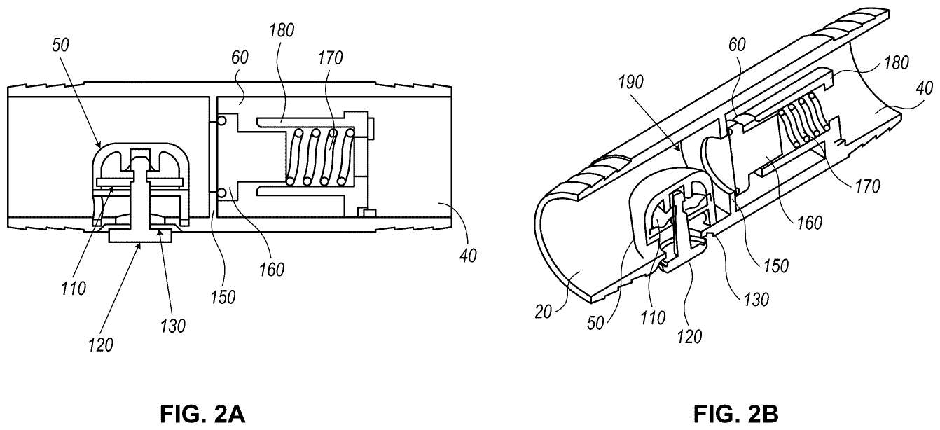

FIGS. 2A-2B illustrate a partial cut away view, and a perspective partial cut away view, respectively, of an example valve assembly 10 utilizing a spring mechanism for control of the outlet valve, FIGS. 2A-2B being described together. Spray valve 50 comprises a diaphragm 110, a spray valve plunger 120 and a spray valve seat 130. Outlet valve 60 comprises an output valve seat 150, and outlet valve plunger 160 and a spring 170.

Diaphragm 110 is contained within a housing within valve assembly 10, such that a first side of diaphragm 110 (above diaphragm 110, in FIGS. 2A-B) at partially encloses a space, with air at the second predetermined pressure, which in the absence of liquid 70 flowing at the opposite side of diaphragm 110 at a pressure substantially above the second predetermined pressure (e.g., about 2 Bar), drives spray valve plunger 120 down to the open state. Thus, in this embodiment, spray valve 50 is in the open state in the absence of a liquid 70 received at input port 20 of at least the predetermined second pressure, i.e. the air pressure in the enclosed space above diaphragm 110, the predetermined second pressure less than the predetermined first pressure. Upon arrival of liquid 70, liquid 70 beings to exit through spray port 30 (FIG. 1A), and the pressure of liquid 70, having at least the predetermined first pressure, and therefore being larger than the air pressure at the first side of diaphragm 110, begins to drive spray plunger 120 towards the closed state, until spray plunger 120 is seated against spray valve seat 130, thereby setting spray port 30 to the closed state (FIG. 1B).

Output valve seat 150 and spring 170 are secured within valve assembly 10, so that spring 170 urges outlet valve plunger 160 against output valve seat 150 so as to retain outlet valve 60 in the closed state. A first end of spring 170 may be secured against an end of retainer 180, and second end of spring 170 may be secured to output valve plunger 160. While liquid 70 is exiting spray port 30, a pressure below the predetermined first pressure is experienced at outlet valve 60, and as a result, outlet valve 60 remains closed. While spray plunger 120 moves to close spray port 30, the pressure of liquid 70 at outlet valve 60 begins to rise. Once spray port 30 is set to the closed state, the pressure of liquid 70 at output valve plunger 160 exceeds the predetermined first pressure, which pressure forces spring 170 to at least partially compress thereby opening outlet valve 60. At this stage, spray port 30 is closed and outlet port 40 is opened. Spring 170 is set so that when the pressure of liquid 70 is below the predetermined first pressure, spring 170 drives output valve plunger 160 against outlet valve seat 150 to set outlet valve 60 to the closed state, and when the pressure of liquid 70 is at, or above, the predetermined first pressure, output valve plunger 160 is driven away from outlet valve seat 150 to set outlet valve 60 to the opened state.

Valve assembly may also comprise a depressurizing port 190 (FIG. 2B) that proceeds from input port 20 to output port 40, to allow the flow of liquid from output port 40 to input port 20 when outlet valve 60 is closed. In one example, outlet valve seat 150 is formed as an annulus formed orthogonally to cylindrical walls of valve assembly 10, and depressurizing port 190 is formed as a hole through the annulus. In one example a check valve (not shown) is provided at port 190, which may be an umbrella valve, so that only when the pressure in the area of input port 20 is lower than the pressure in the area of exit port 40 is the check valve opened so as to allow the flow of liquid from the area of exit port 40 to input port 20. Depressurizing port 190 allows for drainage of valve assembly 10.

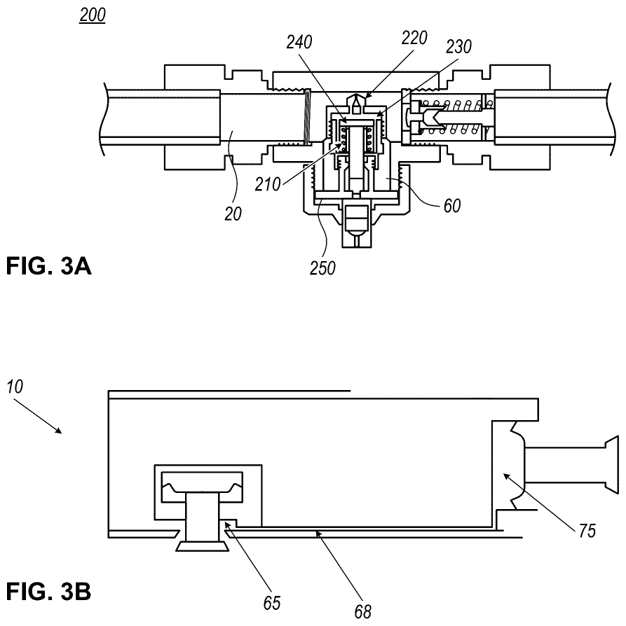

FIG. 3A illustrates a perspective cut away view of another example valve assembly 200 for spraying, which may be another example of valve assembly 10, and is in all respects similar to valve assembly 10, except for spray valve 50, which in this example utilizes a spring 210. A first side of a diaphragm 230 is in liquid communication with input port 20 through a restrictor 220. A second side of diaphragm 230 drives a plunger 250, which plunger 250 is oppositely driven by a respective spring 210. Spring 210 is set so that when the pressure at the first side of a diaphragm 230 is below the predetermined second pressure, spring 210 drives plunger 250 away from spray port 30, and when the pressure at the first side of a diaphragm 230 is at least the predetermined second pressure, the pressure at the first side of a diaphragm 230 urges plunger 250 towards spray port 30. As liquid enters a volume 240 (above diaphragm 230) through restrictor 220, the pressure in the volume 240 increases over the predetermined duration, until the force of spring 210 is overcome, so that after the predetermined duration the pressure in volume 240 forces plunger 250 to close spray valve 50. In the absence of liquid above the predetermined second pressure, spring 210 drives plunger 250 to automatically open outlet valve 60.

FIG. 3B is a cross-sectional view of a valve assembly for sequential, transitory spraying depicting a flow linkage between spray and outlet valves, according to an example. As shown, spray valve 65 is liquid communication with outlet valve 75 through liquid linkage 68. This linkage provides output functionality in accordance with spray valve activity as will be further discussed.

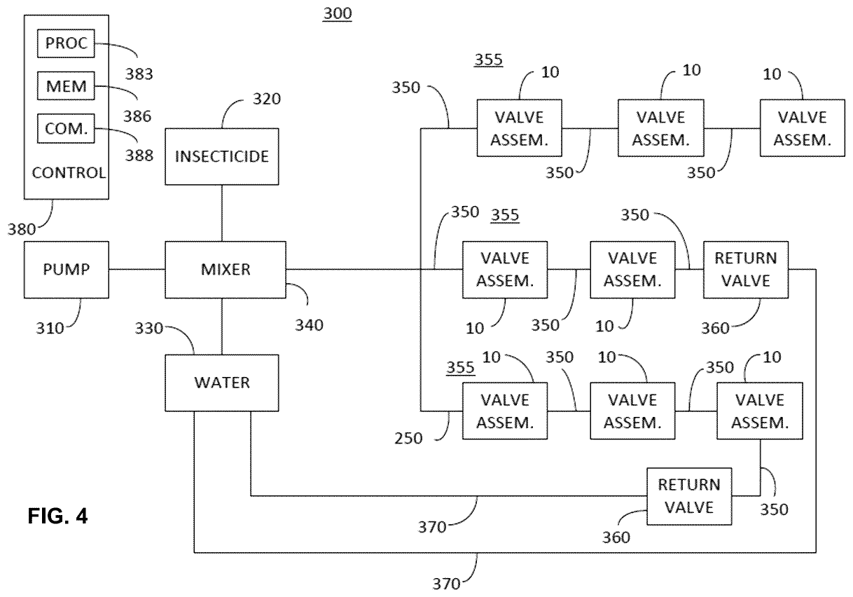

FIG. 4 illustrates an example system 300 for pressure spraying, comprising: a pump 310, an insecticide container 320; a water container 330; a mixer 340; a plurality of sections of a pipe 350; a plurality of valve assemblies 10; at least one return valve 360 with an associated return pipe 370; and a control unit 380 having a processor 383 having a circuit; a memory 386; and a communication unit 388. For simplicity, details of each of the valve assemblies are not shown, and reference to the descriptions above in relation to FIGS. 1A-1B and 2A-C is made.

Pump 310, insecticide container 320, and water container 330 are coupled to mixer 340. Mixer 340 mixes a predetermined quantity of insecticide with a predetermined quantity of water to a predetermined dilution as liquid 70. Pump 310 drives liquid 70 at a pressure above the predetermined first pressure, such as 20 Bar, and liquid 70 is thus driven towards sections of pipe 350. A plurality of branches 355 are depicted, each branch 355 connected in parallel with the other branches 355. The pressure provided by pump 310 is sufficient such that liquid 70 arriving at input port 20 of the ultimate valve assembly 10 in each branch 355 has at least the predetermined first pressure.

In each branch 355, a respective plurality of valve assemblies 10 are connected in series by respective sections of pipe 350. In particular, input port 20 of each valve assembly 10 is coupled to a respective end of a preceding respective pipe section 350 and exit port 40 of each valve assembly 10 is coupled to a respective end of a respective subsequent pipe section 350. Each pipe section 350 may be comprised of a flexible hose or a fixed pipe, without limitation. A proximal end of each branch 355 is coupled to an outlet of mixer 340. A distal end of each branch 355 may be coupled to a first end of a respective return valve 360, with a second end of the respective return valve 360 coupled through a respective return pipe 370 to a return port of water container 330.

Control unit 380 is in communication, via communication unit 388, with each of mixer 340, pump 310, return valve 360 and optionally in communication with each valve assembly 10. In one example, a control valve is provided at the proximal end of each branch 355, which is in bi-directional communication with control unit 380. Memory 386 comprised electronically readable instructions, which when read by processor 383, cause processor 383, and as a result control unit 380, to operate as described herein. Responsive to an input instruction to begin high pressure spraying of insecticide, control unit 380 signals insecticide container 320 to provide insecticide to mixer 340, and signals water container 330 to provide water to mixer 340. Control unit 380 signals mixer 340 to dilute the provided insecticide from insecticide container 320, to a predetermined dilution with water from water container 330, and provide the diluted insecticide as liquid 70. Control unit 380 signals pump 310 to provide liquid 70 to each of branches 355 at a pressure, of at least the first predetermined pressure. Control unit 380 may direct control valves at each, or only some, of the branches 355 to open, and may receive monitoring information, such as flow rate and pressure, from each of the control valves.

Liquid 70 flows through a first pipe section 350 of each branch 355, and enters input port 20 of a first valve assembly 10 in the respective branch 355. As described above, each valve assembly 10 outputs a predetermined amount of liquid 70, or liquid 70 for a predetermined duration, through the respective spray port 30, by the respective spray valve 50, after which the respective spray valve 50 is closed, so that liquid 70 ceases to exit spray port 30. Once the respective spray valve 50 is closed, the respective outlet valve 60 is opened, and the liquid 70 proceeds through the respective outlet port 40 to a subsequent pipe section 350 to then arrive at a subsequent valve assembly 10.

Thus, for each branch 355, each valve assembly 10, in turn, outputs a predetermined amount of liquid 70, or liquid 70 for a predetermined duration, through its respective spray port 30. As described above in relation to FIGS. 2A-C, in one example, each valve assembly 10 is responsive the pressure of liquid 70 to output the predetermined amount of liquid 70, or liquid 70 for the predetermined duration, after which spray valve 50 is closed automatically, and outlet valve 60 opens responsive to the ensuing pressure as a result of spray valve 50 in the closed state. Liquid 70 is then provided to the subsequent valve assembly 10, until all the valve assemblies 10 of the branch 355 have output the predetermined amount of liquid 70, or liquid 70 for the predetermined duration. It is to be noted, that in one example, only one valve assembly per branch 355 outputs liquid 70 from its respective spray port 30 at a time.

In another example, each of the valve assemblies 10 are responsive to control unit 380, which first signals the respective spray valve 50 of a first valve assembly 10 to open for a predetermined duration, and then signals the respective spray valve 50 of the first valve assembly 10 to close. The respective outlet valve 60 may open automatically, as described above, or may be responsive to a signal from control unit 380 to open subsequent to the spray valve 50 being closed. Liquid 70 is then provided to the subsequent valve assembly 10, which is controlled in a like manner, until all the valve assemblies 10 of the branch 355 have output the predetermined amount of liquid 70, or liquid 70 for the predetermined duration.

Rinsing of system 300 is accomplished by control unit 380 signaling insecticide container 320 to cease delivery of insecticide to mixer 340, or by instructing mixer 340 to provide exclusively a rinse agent. The rinse agent may be water from water container 330. Control unit 380 instructs respective return valves 360 to open, thereby enabling flow of liquid 70 from the distal valve assembly 10 to return pipe 370, which return liquid 70 may be reused or discarded.

In one example, resetting of system 300 is performed by control unit 380 signaling pump 310 to reduce the pressure of liquid 370 to below the predetermined second pressure, thereby closing each of respective outlet valves 60 and opening each of the respective spray valves 50 which are thus reset to be ready to release another transitory spray when the pressurized liquid will be reapplied at a pressure of at least the first predetermined pressure, or above. In one example, as described above, a depressurizing valve, such as depressurizing valve 190 (FIG. 2B), allows for drainage of system 300. In one example, mixer 340 is provided with a 3-way valve (not shown), which thus allows for drainage of each branch 350.

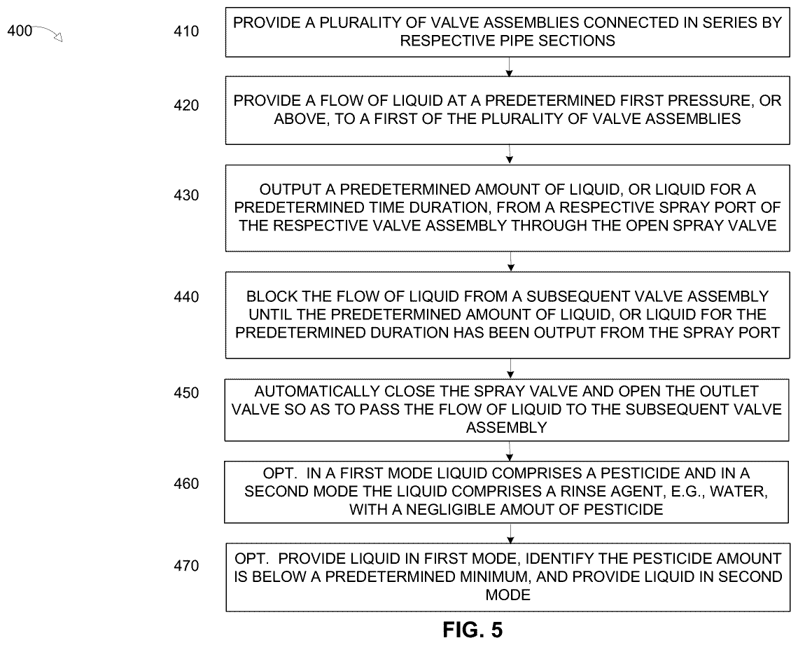

FIG. 5 is a flowchart illustrating an example method of spraying in a certain embodiment. In stage 410, a plurality of valve assemblies is provided, connected in series by respective pipe sections. In stage 420, a flow of liquid is provided at a predetermined first pressure, or above, to a first of the plurality of valve assemblies. In stage 430, a predetermined amount of liquid, or liquid for a predetermined duration, is output from a respective spray port of the respective valve assembly, through a respective open spray valve. In stage 440, which optionally occurs contemporaneously with stage 403, the flow of liquid is blocked from a subsequent valve assembly, and thereby from all subsequent valve assemblies connected in series, until the predetermined amount of liquid, or liquid for the predetermined duration, is output from the respective spray port of the respective valve assembly.

In stage 450, which is subsequent to stages 430-440, the spray valve is automatically closed and an outlet valve of the respective valve assembly is automatically opened so as to pass the flow of liquid to the subsequent valve assembly. The subsequent valve assembly, similarly performs stages 430-440, and then in stage 4050 forwards the liquid to yet another subsequent valve assembly, until an ultimate valve assembly in the series performs stage 430-440.

In optional stage 460, in a first mode, the liquid comprises a pesticide, and in a second mode the liquid comprises a rinse agent. In one example the rinse agent comprises water, with a negligible amount of pesticide. The term pesticide includes all of the following, as sub-categories thereof: herbicide; insecticide; nematicide, molluscicide, piscicide, avicide, rodenticide, bactericide, insect repellent, animal repellent, antimicrobial, fungicide, and lampricide, without limitation.

In optional stage 470, liquid is provided in the first mode. When a control unit identifies that the amount of pesticide in a pesticide container is below a predetermined minimum, liquid is provided in the second mode.

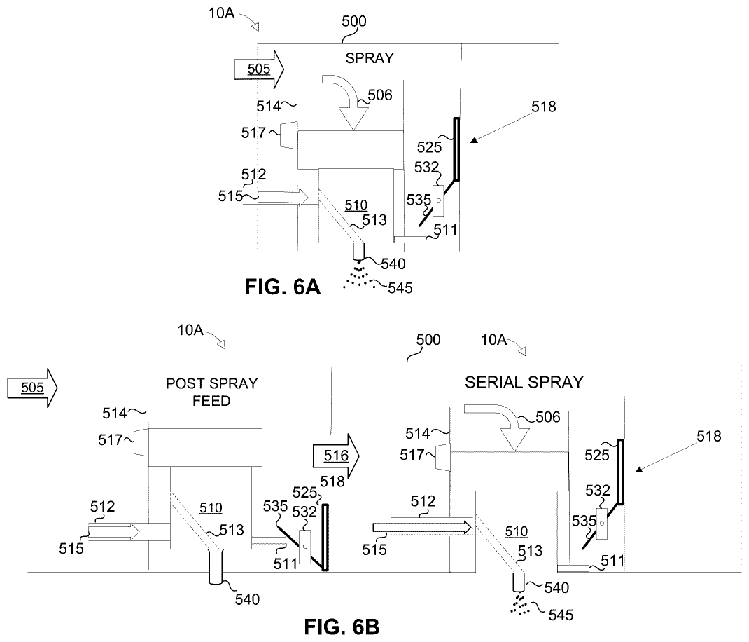

FIGS. 6A-8E depict various implementation options and their operation of the assembly valves presented above.

Specifically, FIG. 6A is a schematic, cross-sectional view of a first embodiment of one transitory spray valve assembly 10A at the first stage of operation. FIG. 6B depicts two spray valve assemblies serially deployed in a pipeline at a later stage of operation in a of operation.

Each valve assembly 10A includes a housing 514 containing a spring biased plunger 510 having a flow pathway 513 and spray port 520. Valve assemblies 10A also include an outlet valve 520 having a flow inhibitor 525 shielding an exit port 518, and a pivotally mounted lever 535 on lever mount 535. Outlet valve 520 is mechanically linked to plunger 510 through lever driver 511 protruding from plunger 510. Lever 535 is configured to enable passage of lever driver 511 during a downstroke of plunger 510 so as not to leverage inhibitor 525 and also assert sufficient rigidity during an upstroke of plunger 510 to cause lever 511 to pivot. Valve assembly 10A also includes a lock mechanism 517 operative to releasably secure plunger 510 in a stationary position after an upstroke following a transitory spray to prevent reopening after the transitory spray thereby allowing the pressurized liquid stream 505 to advance through outlet port 518 to a subsequent valve assembly 10A.

In operation, As shown in FIG. 6A, pressurized liquid stream 505 is directed to a first spray assembly 10A and drives plunger 510 so that plunger passageway 513 is driven into transitory alignment with housing flow path 512 thereby enabling a portion of the flow stream 515 to flow to spray port 540 where it is discharged transitorily as a spray 545. Lever driver 511 is driven with plunger 510 and exerts a force on lever 535. As noted, lever 535 is flexible in one direction and does not receive the lever driver force when applied in this direction. Accordingly, outlet valve 525 remains closed during the release of transitory spray. Transitory spray refers to a spray duration between 0.5-1.0 seconds in a certain embodiment, whereas in another embodiment it has a duration of 0.5-1.5 seconds, whereas in in yet another embodiment it has a duration between 1.0-2.5 seconds for the purposes of this document. In terms of quantity of liquid released, a transitory spray releases between 0.015-0.04 liter in a certain embodiment, between 0.03-0.08 liter in a another embodiment, and between 0.045-0.12 liter in yet another embodiment.

FIG. 6B depicts a post spray state in which transitory spray 545 causes a drop in pressure thereby enabling biased plunger 510 to recoil where it is releasably locked by plunger lock 517 into position. Temporarily securing plunger 510 advantageously facilitates passage of pressurize liquid 505 through outlet port 518 to subsequent valve assembly 10A. During plunger recoil, lever driver 511 applies a force to lever 535 in the direction in which lever 535 exhibits rigidity thereby causing it to pivot on mount 532 and move flow inhibitor 525 and uncover output port 518 thereby allowing pressurized liquid 505 to advance through outlet port 518 to a subsequent valve assembly 10A, as noted above. Once pressurized liquid 505 passes through outlet port 518, it acts on plunger 510 of the subsequent valve assembly 10A as described above. The process is repeated for each valve assembly deployed in series within pipeline 500. Two or more valve assemblies deployed in a pipeline constitute a series. Transitory spray refers to short period of spray time that in certain embodiments is defined by a time, whereas as in other embodiments is defined by the amount of liquid sprayed under a certain pressure, whereas in another embodiment the spray time is defined by difference between opposing forces emanating from biasing elements and flow pressure.

In certain embodiments, lever 535 is implemented from one or more polymeric materials of differing flexibility and arranged to provide the noted directional rigidity and flexibility. In another embodiment, rod 535 is implemented as pivotally connected segmented rod exhibiting rigidity when a force is applied in one direction and flexibility when the force is applied from a different direction, as noted. In certain embodiment, plunger lock 17 is implemented mechanically, whereas in another embodiment it is implemented magnetically.

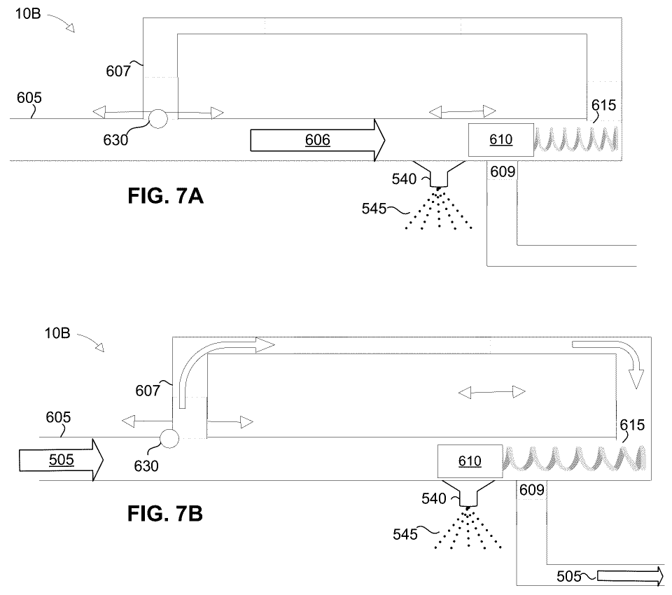

FIGS. 7A-7B are schematic, cross-sectional side views depicting two stages of operation of a second embodiment of a transitory valve assembly 10B.

This embodiment of valve assembly 10B, implements a spray valve as a biased flow restrictor 610 slidingly mounted in assembly flow path 605. Flow restrictor 610 is operative to either impede or to enable flow to spray port 540 in accordance with its position relative to the spray port 540. Valve assembly 10B also includes an outlet valve 630 disposed at a junction between assembly flow path 605 and a bypass 608. Outlet valve 630 is spring biased and operative to open at an outlet pressure exceeding the threshold pressure driving flow restrictor 610.

In operation valve assembly 10B is operative at two pressures of liquid stream 505. Before pressurizing the liquid to a spray valve threshold pressure in assembly flow path 605, flow restrictor 610 is disposed in a default position impeding flow to spray port 610. (Not shown.) Upon pressurizing liquid 505, flow restrictor 610 is driven in assembly flow path 605 away from spray port 540 thereby uncovering it and releasing spray 545 as shown in FIG. 7A. As the pressure increases to an outlet pressure, outlet valve 630 opens and pressurized liquid 505 is diverted into bypass 607 a through outlet port 609 to a subsequent valve assembly upstream as shown in FIG. 7B. Opening outlet port 630 reduces the liquid pressure in assembly flow path 605 thereby allowing spring 615 to recoil and drive restrictor 610 into a flow impeding position and the spray stops. The time required for the liquid pressure to increase from the spray valve threshold pressure to the outlet pressure opening the outlet valve 630 defines the duration of the transitory spray released from spray spot 540. Depressurizing the liquid to pressures below the threshold outlet pressure closes the outlet valve 630.

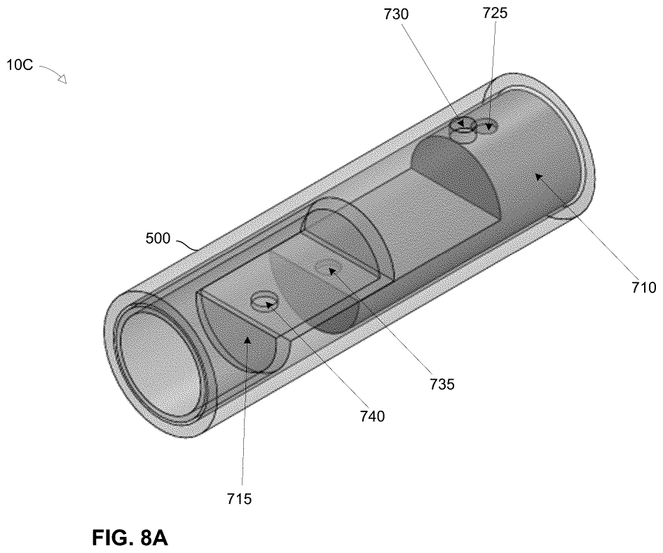

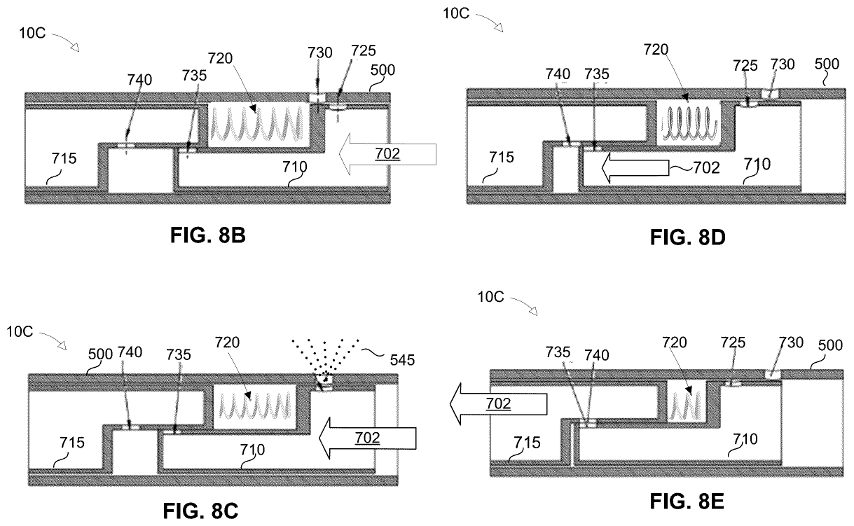

FIG. 8A is perspective view of a third embodiment of a transitory spray assembly 10C. Spray assembly 10C is implemented as an axial plunger 710 longitudinally slidable in a pipeline 500. Axial plunger 710 has a flow passageway 725 alignable with spray port 730 disposed in pipeline 500. Spray assembly 10C includes a static plunger receptable 715 operative to receive axial plunger 710 driven axially by a pressurized liquid inside pipeline 500. Plunger receptable 715 has an outlet port 740 providing liquid throughput from axial plunger 710 when a discharge port 735 of axial plunger 710 is further driven into alignment with the outlet port 740.

FIGS. 8B-8E are schematic cross-sectional views of transitory valve assembly 10C during various stages of operation.

In FIG. 8B, pressurized liquid 702 is directed into axial plunger 710 and drives it inside pipeline 500 against spring 720. Spring stiffness defines the threshold pressure needed to drive axial plunger 710 and the degree of compression achieved by the pressurized liquid acting on plunger 710, as is known to those skilled in the art.

In FIG. 8C, axial plunger 710 has advanced to position bringing flow passageway 725 into alignment with spray port 730 thereby enabling the release of pressurized liquid as a spray 545 during the time of alignment.

In FIG. 8D pressurized liquid 702 further drives axial plunger 710 along pipeline 500 thereby bringing flow passageway 725 into a state of unalignment with spray port 730 thereby terminating transitory spray 545. The duration of the spray transitory 545 is defined by the time of alignment of flow passageway 725 spray port 730.

In FIG. 8E, pressurized liquid 702 further drives axial plunger 710 along pipeline 500 thereby bringing a discharge port 735 of axial plunger 710 into alignment with outlet port 740 thereby enabling liquid stream 702 to exit valve assembly 10C and continue downstream to the next valve assembly.

It should be appreciated that all transitory valve assemblies are constructed from polymeric or metallic materials, or a combination of both. Biasing elements are implemented as metallic or polymeric springs. The springs are implemented as compression springs, however in certain embodiments they are implemented as extension springs, whereas in another embodiment they are implements torsion springs.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description and which are not in the prior art.

1. A system for sequential transitory spraying along at least one pipeline when subjected to a pressurized liquid, the system comprising:
a series of valve assemblies deployed along the pipeline, wherein each of the valve assemblies comprises:
a spray valve configured to release a transitory spray through a spray port when the spray valve is subjected to a change in pressure of the pressurized liquid in the pipeline, wherein the port: (1) responsively opens when the pressure increases at or above a threshold pressure; (2) automatically closes thereafter; and (3) reopens to release a further transitory spray only (a) if the pressure of the pressurized liquid initially reduces below the threshold pressure; and (b) when the pressure of the pressurized liquid subsequently increases above the threshold pressure; and
an outlet valve configured to: (i) open after the release of the transitory spray when the pressurized liquid increases at or above an outlet-threshold pressure; (ii) to remain open, so as to enable passage of the pressurized liquid downstream through an outlet port to a subsequent valve assembly; and (iii) to close when the pressurized liquid reduces below the outlet-threshold pressure.

2. The system of claim 1, wherein the outlet-threshold pressure exceeds the threshold pressure.

3. The system of claim 2, wherein the spray valve is implemented as a biased plunger having a flow passageway aligning with the spray port when driven by the threshold pressure.

4. The system of claim 3, wherein the plunger is biased to recoil responsively to a pressure less than the threshold pressure applied by the pressurized liquid.

5. The system of claim 4, further comprising a plunger lock configured to releasably lock the plunger into place after the recoil.

6. The system of claim 4, wherein the outlet valve is configured to open responsively to the recoil of the plunger.

7. The system of claim 1, wherein the spray valve is implemented as a biased, flow restrictor operative to open a flow path to the spray port responsively to a threshold pressure applied by the pressurized liquid in the pipeline.

8. The system of claim 1, wherein the outlet valve is operative to open responsively to an outlet-threshold pressure applied by the pressurized liquid, the outlet-threshold pressure exceeding the threshold pressure, the outlet valve disposed at junction between an assembly flow path and a spray valve bypass loop.

9. The system of claim 1, wherein the spray valve is implemented as a biased, axial plunger having a flow passageway aligning with the spray port when driven axially by the threshold pressure.

10. The system of claim 9, wherein the outlet valve is implemented as the biased, axial plunger having a discharge port operative to align with the outlet port when further driven by the pressure pressurized liquid.

11. A method of sequential transitory spraying of pressurized liquid from a series of spray assemblies serially deployed in at least one pipeline, the method comprising:
(A) transitorily releasing a transitory spray of the pressurized liquid in the pipeline through a spray valve of a spray assembly of the series of spray assemblies when the spray valve is subjected to a change in pressure of the pressurized liquid, by: (1) opening a spray port of the spray valve in response to an increase of pressure at or above a threshold pressure; (2) automatically closing the spray port after the release of the transitory spray; and (3) reopening the spray port to release a further transitory spray only (a) if the pressure of the pressurized liquid initially reduces below the threshold pressure; and (b) when the pressure of the pressurized liquid subsequently increases above the threshold pressure; and
(B) opening and closing an outlet valve of the spray assembly, by (i) opening the outlet valve after the release of the transitory spray when the pressurized liquid increases at or above an outlet-threshold pressure; (ii) maintaining the outlet valve open so as to apply the pressurized liquid downstream through an outlet port to a subsequent spray assembly of the series of spray assembles deployed downstream in the pipeline; and (iii) closing the outlet valve when the pressurized liquid reduces below the outlet-threshold pressure.

12. The method of claim 11, wherein the releasing a spray of the pressurized liquid in the pipeline is implemented by transitorily aligning a flow passageway of the spray valve in liquid communication with the pressurized liquid with the spray port.

13. The method of claim 11, wherein the opening of an outlet valve of the spray assembly is implemented by removing a flow inhibitor shielding an outlet port.

14. The method of claim 11, the transitorily releasing a spray of the pressurized liquid in the pipeline through a spray valve is implemented by transitorily removing a flow restrictor impeding flow to a spray port.

15. The method of claim 11, wherein the opening of an outlet valve of the spray assembly is implemented by applying a heightened pressure of the pressurized liquid to the outlet valve.

16. The method of claim 15, further comprising depressurizing the pressurized liquid so as to close the outlet valve.

17. The method of claim 11, wherein the releasing of a spray of the pressurized liquid in the pipeline is implemented by axially driving an axial plunger having a flow passageway in communication with the pressurized liquid, the axially driving causing alignment of the flow passageway with a spray port.

18. The method of claim 11, wherein the opening an outlet valve of the spray assembly is implemented by further axially driving the axial plunger having a discharge port in communication with the pressurized liquid, the further axially driving causing alignment of the discharge port with the outlet port.

19. The method of claim 18, further comprising depressurizing the pressurized liquid so as to close the outlet valves.

20. A valve assembly deployed in a pipeline for sequential transitory spraying along the pipeline when subjected to a pressurized liquid, comprising:
a spray valve configured to release a transitory spray through a spray port when a pressurized liquid is applied to the spray valve deployed in the pipeline, wherein the port: (1) responsively opens when the pressure increases at or above a threshold pressure; (2) automatically closes thereafter; and (3) reopens to release a further transitory spray only (a) if the pressure of the pressurized liquid initially reduces below the threshold pressure; and (b) when the pressure of the pressurized liquid subsequently increases above the threshold pressure; and
an outlet valve configured to: (i) open after the release of the transitory spray when the pressurized liquid increases at or above an outlet-threshold pressure; (ii) to remain open, so as to enable passage of the pressurized liquid downstream through an outlet port to a subsequent valve assembly; and (iii) to close when the pressurized liquid reduces below the outlet-threshold pressure.
